(19) United States
(12) Patent Application Publication
(10) Pub. No.: US 2020/0224464 A1
(43) Pub. Date: Jul. 16, 2020

(54) SMART LATCH ASSEMBLY WITH ACTUATOR MODULE

(71) Applicant: MAGNA CLOSURES INC., Newmarket (CA)

(72) Inventor: Francesco CUMBO, Pisa (IT)

(21) Appl. No.: 16/737,796

(22) Filed: Jan. 8, 2020

Related U.S. Application Data
(60) Provisional application No. 62/790,512, filed on Jan. 10, 2019.

(51) Int. Cl. E05B 81/16; E05B 79/02; E05B 85/02; E05B 81/54; E05B 81/34; E05B 77/38

(52) U.S. Cl. CPC E05B 81/16; E05B 79/02; E05B 77/38; E05B 81/54; E05B 81/34; E05B 85/02

(57) ABSTRACT

A closure latch assembly, comprising a latch module including a mechanism operable in a first state and in a second state, an actuator module including a power actuator for shifting the mechanism from its first state into its second state, and a control unit for controlling actuation of the power actuator, and an attachment arrangement for securing the actuator module to the latch module.

### CROSS-REFERENCE TO RELATED APPLICATION

This application claims the benefit of U.S. Provisional Application Ser. No. 62/790,512, filed Jan. 10, 2019, which is incorporated herein by way of reference in its entirety.

### FIELD

The present disclosure relates to generally to power-operated closure latch assemblies of the type used in closure systems for releaseably latching a closure panel to a body portion of a motor vehicle. More particularly, the present disclosure is directed to a closure latch assembly having a standardized actuator module capable of being attached to a plurality of different latch modules and which is configured to include an ECU/actuator assembly and an ECU cover.

### BACKGROUND

This section provides background information which is not necessarily prior art to the inventive concepts embodied in the present disclosure.

Continued increases in technology, driven by consumer demand for advanced comfort and convenience features, has resulted in more electronics being integrated in modern motor vehicles. To this end, electronic controllers and electronically-controlled devices are now used to control a wide variety of functions in the vehicle. For example, many modern vehicles are now equipped with a passive (i.e. “keyless”) entry system to permit locking/unlocking and release of closure panels (i.e. doors, tailgates, liftgates, decklids, etc.) without the use of a traditional key-type entry system. In this regard, some popular functions now available with such passive entry systems include power lock/unlock, power cinch, and power release. Thus “powered” functions are provided by a closure latch assembly mounted to the closure panel and which is equipped with a latch module having a ratchet/pawl type of latch mechanism that is selectively actuated via actuation of at least one electric actuator. A latch control unit is electronically connected to the electric actuator for controlling actuation of the electric actuator.

Movement of the closure panel from an open position toward a closed position results in a striker (mounted to a structural portion of the vehicle) engaging and forcibly rotating the ratchet, in opposition to a biasing force normally applied to the ratchet via a ratchet biasing member, from a striker release position toward a striker capture position. Once the ratchet is located in its striker capture position, the pawl moves, due to the urging of a pawl biasing member, into a ratchet holding position whereat the pawl mechanically engages and holds the ratchet in its striker capture position, thereby latching the latch mechanism and holding the closure panel in its closed position. A latch release mechanism is commonly associated with the latch module for causing movement of the pawl from its ratchet holding position into a ratchet releasing position whereat the pawl is disengaged from the ratchet. Thereafter, the ratchet biasing member drives the ratchet back to its striker release position, thereby releasing the latch mechanism and permitting movement of the closure panel to its open position.

Closure latch assemblies providing a power release feature typically have the electric “power release” actuator configured to actuate the latch release mechanism for releasing the latch mechanism. The electric power release actuator is part of the latch module and is controlled via the latch control unit in response to a latch release signal generated by the passive entry system (i.e. via a key fob or a handle-mounted switch). In many instances, the latch control unit is part of an electronic controller unit (ECU) module. Conventionally, the ECU module has been located remotely from the closure latch assembly and is electrically connected to the electric power release actuator via a wiring harness. More recently, closure latch assemblies have been developed with the ECU module mounted directly to the latch module to provide an integrated configuration which permits elimination of the wiring harness.

Typically, the ECU module includes at least one circuit board, such as a printed circuit board (PCB), configured to supply electrical power to, and control operation of, the power actuator based on the control circuits and electrical components on the circuit board. In addition, the ECU module may include backup power devices (i.e. capacitors, super capacitors, backup batteries, etc.) which are also mounted to the circuit board and function to provide electrical power in the event of a loss of power from the vehicle's battery. These backup power devices are much larger, in terms of mass and size, than the other electrical components mounted to the circuit board. Since the circuit board(s), electrical components and backup power devices are sensitive to environmental damage, the ECU module typically includes a protective, fluid-tight enclosure assembly to prevent the ingress of dirt and moisture.

Another issue with conventional ECU modules, especially those mounted to a moveable closure panel, is that the electrical components and backup power devices are subjected to high deceleration forces when the closure panel reaches its end of travel (i.e. open and fully-closed) positions. These deceleration forces can be significant and can potentially cause the electrical components and/or the backup power devices to be jarred and eventually damages or detached from the circuit board. Accordingly, the enclosure assembly also is designed to absorb or otherwise dampen these deceleration forces.

While closure latch assemblies having an integrated configuration for the latch module and ECU module provide size and packaging advantages, the need to develop a specific or “dedicated” ECU module configured to mate with each latch module adds complexity and cost. To this end, it would be desirable to develop a standardized or “stand-alone” ECU module having an enclosure assembly adapted to be attached to different latch modules so as to provide interchangeable configurations. In addition to the logistical advantages of having a standardized ECU module capable of being used with different latch modules or different versions of the same latch module, the ECU module could be tested, calibrated and/or debugged independently of the latch module.

In view of the above, there is a recognized need to develop a stand-alone ECU module that is configured to protect the electrical components and backup power devices against damage from exposure to environmental elements and high deceleration forces, that is cost effective to develop and manufacture, and that can be easily adapted to a variety of different latch modules. Moreover, while current power-operated closure latch assemblies are sufficient to meet all regulatory requirements and provide the desired consumer expectations for enhanced comfort and convenience, a need exists directed toward advancing the technology and providing alternative power-operated closure latch assemblies that address and overcome at least some of the known shortcomings associated with conventional arrangements.

### SUMMARY

This section provides a general summary of various aspects, features and structural embodiments provided by or associated with the inventive concepts hereinafter disclosed in accordance with the present disclosure and is not intended to be a comprehensive summation and/or limit the interpretation and scope of protection afforded by the claims.

In an aspect, this disclosure provides a closure latch assembly including a latch module and an actuator module configured to be mounted with and secured to the latch module.

In a related aspect, the actuator module is a stand-alone standardized device configured to be directly secured to a plurality of different latch modules.

In another aspect, the actuator module includes a power actuator operable for actuating a mechanism associated with the latch module to provide a “powered” function, and an ECU controlling actuation of the power actuator.

In accordance with these and other aspects, the closure latch assembly of the present disclosure includes a latch module including a mechanism operable in a first state and in a second state; an actuator module including a power actuator for shifting the mechanism from its first state into its second state, and a control unit for controlling actuation of the power actuator; and an attachment arrangement for securing the actuator module to the latch module.

In a related aspect, the actuator module includes a housing plate having a first side facing the latch module and an opposite second side, and having a port extending from the first side to the opposite second side, and the power actuator includes an electric motor provided on the opposite second side, the electric motor having a motor shaft extending through the port.

The actuator module associated with the closure latch assembly of the present disclosure includes an ECU/actuator assembly and an ECU cover. The ECU/actuator assembly includes a housing plate, and the control unit is mounted to and at least partially over-molded on the housing plate. The control unit includes a printed circuit board (PCB) having at least one of an electrical connector and a backup power device, and the control unit and the power actuator are part of a common assembly. The power actuator includes a carrier plate secured to housing plate, an electric motor secured to the carrier plate and driving a drive pinion, a drive gear rotatably mounted to the carrier plate and meshed with the drive pinion, and a gear stop bumper secured to the carrier plate. The drive gear includes an actuation feature operatively connected to the mechanism within the latch module such that rotation of the drive gear from the first position to a second position via energization of the electric motor results in shifting of the mechanism from its first state into its second state.

In accordance with these and other aspects, the present disclosure is directed to a method of manufacturing an actuator module including a power actuator for shifting states of a latch module including a mechanism operable in a first state and in a second state, the power actuator including a carrier plate, an electric motor securable to the carrier plate and comprising a motor shaft driving a drive pinion, and a drive gear rotatably mounted to the carrier plate and meshed with the drive pinion, the method comprising the steps of: overmolding the carrier plate to a housing plate comprising a first side and a second side; forming a port in the housing plate for receiving the motor shaft therethrough extending from the first side to the second side; sealing the port; securing the electric motor to the carrier plate on the first side of the housing plate; positioning a control unit for controlling actuation of the power actuator on the first side of the housing plate; and connecting the control unit to the electric motor.

In accordance with these and other aspects, the actuator module of the present disclosure includes an ECU/actuator assembly, an ECU cover, and an attachment arrangement for attaching the ECU cover to the ECU/actuator assembly and for attaching the actuation module to the latch module. The ECU/actuator assembly is generally configured to include a housing plate and a control unit mounted to and at least partially overmolded on the housing plate. The control unit is generally configured to include a printed circuit board having electrical contacts and at least one backup power source mounted thereon, and a power actuator. The power actuator includes a carrier plate adapted to be secured to the housing plate, an electric motor secured to the carrier plate and having a motor shaft driving a drive pinion, a drive gear rotatably mounted to the carrier plate and in constant mesh with the drive pinion, an actuation feature extending from the drive gear and configured to interact with a latch mechanism of the latch module, and a gear stop bumper mounted to the carrier plate. The axis of rotation of the motor shaft being generally aligned in parallel with a pivotable member of the latch mechanism.

In accordance with yet another aspect, there is provided a closure latch assembly, including a latch module including a mechanism operable in a first state and in a second state, and an actuator module including a housing plate comprising a first side facing the latch module and an opposite second side, and a port extending from the first side through to the opposite second side, a power actuator provided on the opposite second side and comprising a motor shaft extending through the port, the power actuator for shifting the mechanism from its first state into its second state, and a control unit provided on the opposite second side for controlling actuation of the power actuator.

These and other aspects and areas of applicability will become apparent from the description provided herein. The description and specific examples in this summary are solely intended for purpose of illustration and are not intended to limit the scope of the present disclosure. The drawings that accompany the detailed description are described below.

### DRAWINGS

The drawings described herein are for illustrative purposes only of selected non-limiting embodiments and not all possible or anticipated implementations thereof, and are not intended to limit the scope of the present disclosure.

FIG. 1 is an isometric view of a motor vehicle equipped with a closure system including a closure latch assembly shown mounted to a vehicle door;

FIG. 2 is an isometric view of a closure latch assembly adapted for use in the closure system shown in FIG. 1 and which is configured to include a latch module and an actuator module constructed to embody the inventive concepts of the present disclosure;

FIG. 3 is a top view of the closure latch assembly shown in FIG. 2;

FIG. 4 is a plan view of the closure latch assembly shown in FIG. 2;

FIG. 5 is a side view of the closure latch assembly shown in FIG. 2;

FIG. 6 is a diagrammatical view of the closure latch assembly shown in FIGS. 2-5 which illustrates various components of the latch module and the actuator module;

FIGS. 7A through 7D illustrate a non-limiting example embodiment of the latch module;

FIGS. 8 and 9 are isometric views of the actuator module constructed according to a first embodiment of the present disclosure and which includes an ECU cover and an ECU/actuator assembly;

FIGS. 10 and 11 are isometric views of the ECU/actuator assembly associated with the actuator module shown in FIGS. 8 and 9 and which includes a housing plate and a control unit overmolded on the housing plate;

FIGS. 12 and 13 are isometric views of the control unit associated with the ECU/actuator assembly shown in FIGS. 10 and 11 and which includes a printed circuit board (PCB), a pack of super capacitors, and a power actuator;

FIGS. 14 and 15 are isometric views of the power actuator associated with the control unit shown in FIGS. 12 and 13 and which includes a carrier plate, an electric motor mounted to the carrier plate and driving a drive pinion, a drive gear rotatably supported by the carrier plate and in meshed engagement with the drive pinion, and a bumper stop mounted to the carrier plate;

FIG. 16 illustrates an interface and functional relationship between an actuation feature on the drive gear and a release feature on a pawl associated with an exemplary ratchet and pawl latch mechanism within the latch module;

FIGS. 17 and 18 illustrate an actuator module for the closure latch assembly now constructed according to a second embodiment of the present disclosure having a modified ECU cover and seal arrangement to accommodate a maximized glass run channel within the vehicle door;

FIG. 19 illustrates an actuator module for the closure latch assembly now constructed according to a third embodiment of the present disclosure having a modified ECU cover and a modified ECU/actuator assembly with the PCB and related housing components revised to accommodate a maximized glass run channel within the vehicle door;

FIG. 20 illustrates an actuator module for the closure latch assembly now constructed according to a fourth embodiment of the present disclosure having a modified ECU cover and ECU/actuator assembly with the PCB and related housing components revised in combination with a rearrangement of the electric motor and the connector to accommodate a maximized glass run channel within the vehicle door;

FIG. 21 illustrates a method for assembling the actuator module;

FIG. 22 illustrates a method of assembling an actuator module, in accordance with an illustrative embodiment;

FIG. 23 is a top isometric view of the actuator module constructed according to another embodiment of the present disclosure;

FIG. 24 is a bottom isometric view of the actuator module of FIG. 23 illustrating two actuation features provided on a first side of the housing plate of the actuator module;

FIG. 25 is a bottom perspective view of the actuator module of FIG. 23, illustrating two components extending through sealed ports provided in the housing plate of the actuator module, in accordance with an illustrative embodiment;

FIG. 26 is an isometric view of the control unit associated with the actuator module of FIG. 23 and shown to includes a printed circuit board (PCB), a pack of super capacitors, and a pair of power actuators, in accordance with an illustrative embodiment;

FIG. 27 is an enlarged isometric view of the control unit of FIG. 26 illustrating the pair of power actuators each provided with an actuation feature, in accordance with an illustrative embodiment; and

FIG. 28 is an enlarged bottom perspective view of the actuator module of FIG. 24 illustrating a common carrier plate supporting the pair of power actuators, in accordance with an illustrative embodiment.

Corresponding reference numbers are used to indicate corresponding components throughout the several views associated with the above-identified drawings;

### DETAILED DESCRIPTION

Example embodiments will now be described more fully with reference to the accompanying drawings. To this end, the example embodiments are provided so that this disclosure will be thorough, and will fully convey its intended scope to those who are skilled in the art. Accordingly, numerous specific details are set forth such as examples of specific components, devices, and methods, to provide a thorough understanding of embodiments of the present disclosure. However, it will be apparent to those skilled in the art that specific details need not be employed, that example embodiments may be embodied in many different forms, and that neither should be construed to limit the scope of the present disclosure. In some example embodiments, well-known processes, well-known device structures, and well-known technologies are not described in detail.

In the following detailed description, the expression “closure latch assembly” will be used to generally, as an illustrative example, indicate any power-operated latch device adapted for use with a vehicle closure panel to provide a “powered” (i.e. release, cinch, lock/unlock, etc.) feature. Additionally, the expression “closure panel” will be used to indicate any element moveable between an open position and at least one closed position, respectively opening and closing an access to an inner compartment of a motor vehicle and therefore includes, without limitations, decklids, tailgates, liftgates, bonnet lids, and sunroofs in addition to the sliding or pivoting side passenger doors of a motor vehicle to which the following description will make explicit reference, purely by way of example.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “compromises,” “comprising,” “including,” and “having,” are inclusive and therefore specify the presence of stated features, integers, steps, operations, elements, and/or components, but do not preclude the presence or addition of one or more other features, integers, steps, operations, elements, and/or components, but do not preclude the presence or addition of one or more other features, integers, steps operations, elements, components, and/or groups thereof. The method steps, processes, and operations described herein are no to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

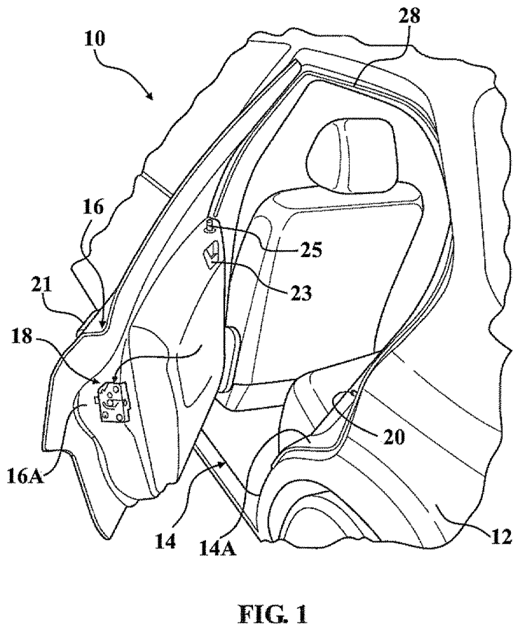

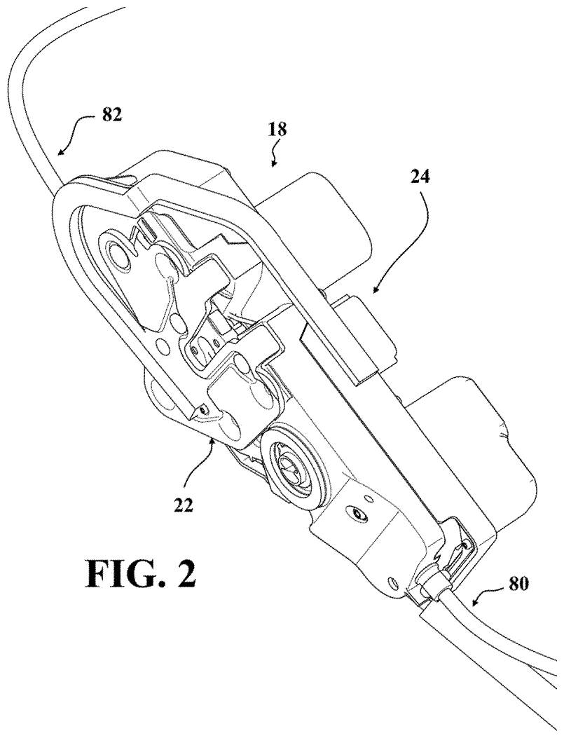

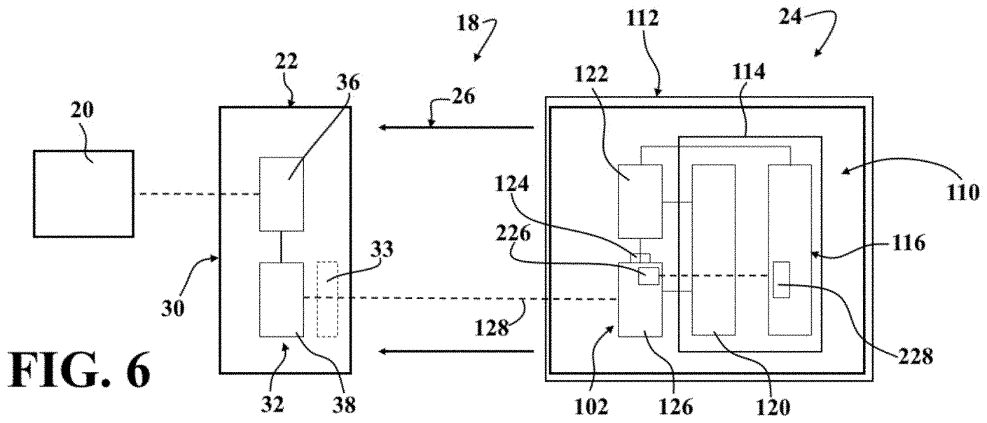

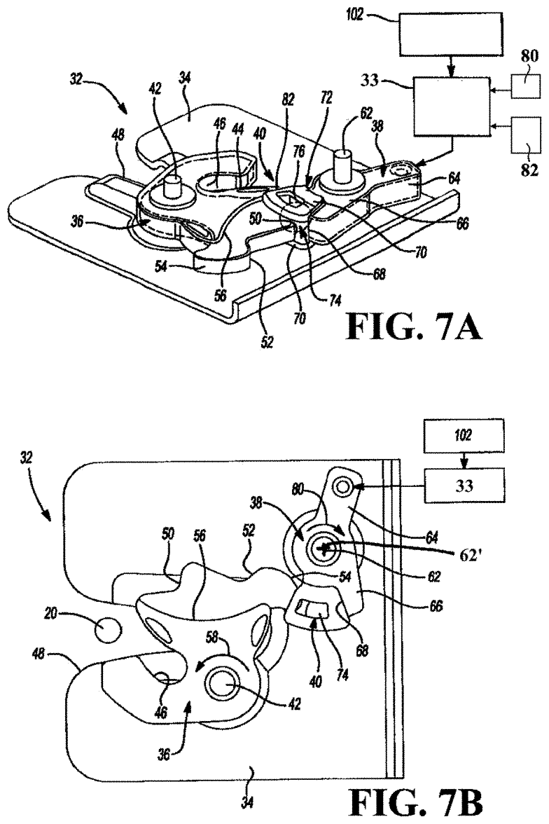

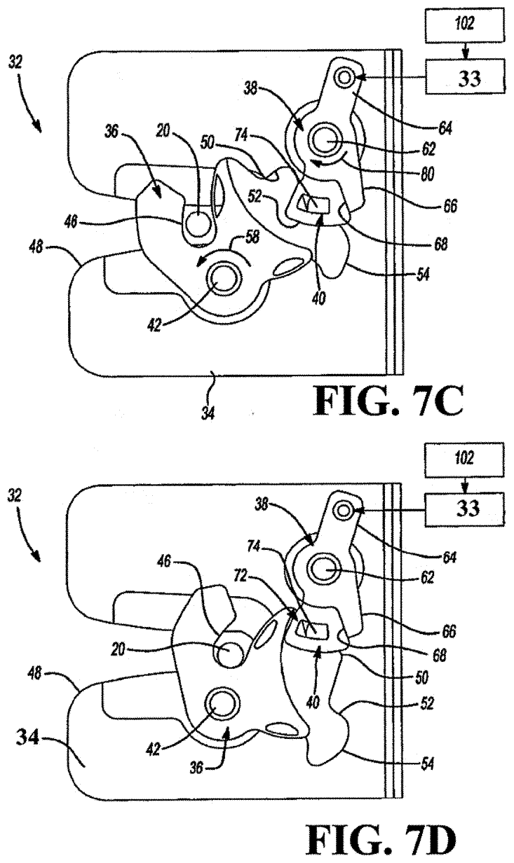

Referring initially to FIG. 1 of the drawings, a motor vehicle 10 is shown to include a vehicle body 12 defining an opening 14 to an interior passenger compartment. A closure panel 16 is pivotably mounted to vehicle body 12 for movement between an open position (shown), a partially-closed position, and a fully-closed position relative to opening 14. A closure latch assembly 18 is rigidly secured to closure panel 16 adjacent to an edge portion 16A thereof and is releasably engageable with a striker 20 that is fixedly secured to a recessed edge portion 14A of vehicle body 12 forming a portion of opening 14. As will be detailed, closure latch assembly 18 is generally comprised of a latch module 22, an actuator module 24, and an attachment arrangement 26 connecting actuator module 24 to latch module 22 and providing a sealed interface therebetween. Latch module includes a latch mechanism 32 (FIGS. 6 and 7) operable to engage striker 20 and releaseably hold closure panel 16 in one of its partially-closed and fully-closed positions. An outside handle 21 and an inside handle 23 are provided for actuating (i.e. mechanically and/or electrically) closure latch assembly 18 to release striker 20 and permit subsequent movement of closure panel 16 to its open position. An optional lock knob 25 is shown which provides a visual indication of the locked state of closure latch assembly 18 and which may also be operable to mechanically change the locked state of closure latch assembly 18. A weather seal 28 is mounted on edge portion 14A of opening 14 in vehicle body 12 and is adapted to be resiliently compressed upon engagement with a mating sealing surface on closure panel 16 when closure panel 16 is held by closure latch assembly 18 in its fully-closed position so as to provide a sealed interface therebetween which is configured to prevent entry of rain and dirt into the passenger compartment while minimizing audible wind noise. For purpose of clarity and functional association with motor vehicle 10, the closure panel is hereinafter referred to as door 16. FIGS. 2 through 5 illustrate various views of closure latch assembly 18 prior to installation in door 16 and show the general orientation of actuator module 24 relative to latch module 22.

Referring now to FIG. 6, a diagrammatical version of closure latch assembly 18 illustrates the general orientation of latch module 22, actuator module 24, and attachment arrangement 26. Latch module 22 generally includes a latch housing 30 within which the components of latch mechanism 32 and a latch release mechanism 33 are supported. For purposes of illustration only, a non-limiting version of latch mechanism 32 is shown in FIGS. 7A-7D, generally include a latch frame plate 34, ratchet 36, and a pawl 38 having a roller-type engagement device 40, by way of example and without limitation, such as disclosed in US Publication No. 2019/0242163, filed under U.S. application Ser. No. 16/268,603 on Feb. 16, 2019, owned by Applicant herein, which is incorporated herein by way of reference in its entirety. Ratchet 36 is supported on latch frame plate 34 by a ratchet pivot post 42 for movement between a released or “striker release” position (FIG. 7B), a soft close or “secondary striker capture” position (FIG. 7C), and a hard close or “primary striker capture” position (FIGS. 7A and 7D). Ratchet 36 includes a striker guide channel 44 terminating in a striker retention cavity 46. As seen, latch frame plate 34 includes a fishmouth slot 48 aligned to accept movement of striker 20 relative thereto upon movement of door 16 toward its closed positions. Ratchet 36 includes a primary latch notch 50, a secondary latch notch 52, and an outer peripheral edge surface 54. A laterally outwardly extending, raised guide surface 56 is also formed on ratchet 36. Arrow 58 (FIGS. 7B and 7C) indicates a ratchet biasing member that is arranged to normally bias ratchet 36 toward its striker release position.

Pawl 38 is shown pivotably mounted to latch frame plate 34 about a pawl pivot post 62 and includes a first pawl leg segment 64 and a second pawl leg segment 66 defining a pawl engagement surface 68. Roller-type engagement device 40 is secured to second pawl leg segment 66 of pawl 38 and includes a pair of oppositely-disposed sidewalls 70 defining a cage 72, and a roller, shown as a spherical ball bearing 74, that is retained by cage 72 within aligned roller slots 76 formed in sidewalls 70. Pawl 38 is pivotable between a ratchet releasing position (FIG. 7B) and a ratchet holding position (FIGS. 7A, 7C and 7D). Pawl 38 is normally biased toward its ratchet holding position by a pawl biasing member, indicated by arrow 80 (FIGS. 7B and 7C).

As shown in FIG. 7B, pawl 38 is held in its ratchet releasing position when ratchet 36 is located in its striker release position due to engagement of ball 74 with pawl engagement surface 68 on pawl 38 and with edge surface 54 on ratchet 36, whereby a released operating state for latch mechanism 32 is established. As shown in FIG. 7C, ball 74 is in engagement with pawl engagement surface 68 on pawl 38 and with secondary latch notch 52 on ratchet 36 so as to cause pawl 38, now located in its ratchet holding position, to hold ratchet 36 in its secondary striker capture position. In this orientation, striker 20 is retained between ratchet guide channel 46 and fishmouth slot 48 in latch plate 34 to hold door 16 in a partially-closed position and establish a secondary latched state for latch mechanism 32. Finally, FIGS. 7A and 7D illustrate pawl 38 located in its ratchet holding position with ball 74 in engagement with pawl engagement surface 68 on pawl 38 and with primary latch notch 50 on ratchet 36 such that pawl 38 holds ratchet 36 in its primary striker capture position so as to hold door 16 in its fully-closed position and establish a primary latched operating state for latch mechanism 32.

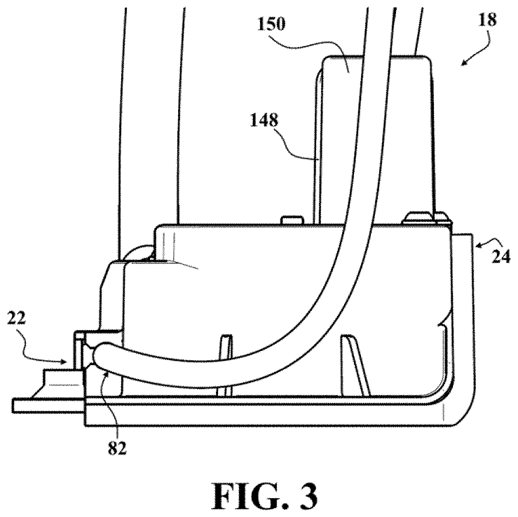

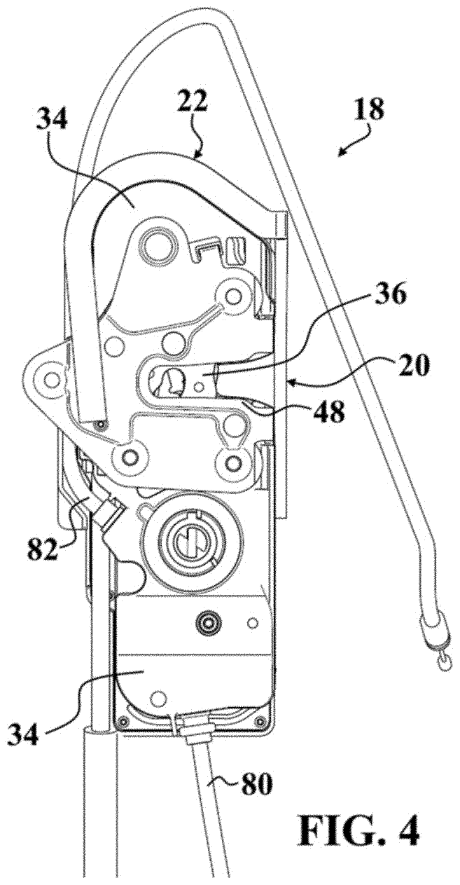

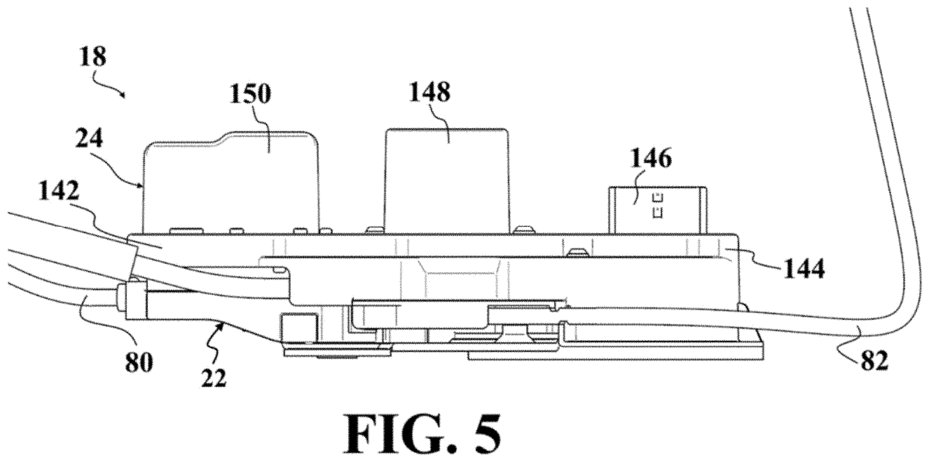

Latch release mechanism 33 is shown schematically to be connected to first pawl leg segment 64 of pawl 38. Latch release mechanism 33 functions to cause movement of pawl 38 from its ratchet holding position into its ratchet releasing position when it is desired to shift latch mechanism 32 into its released operating state. An inside latch release mechanism (see cable 80 in FIGS. 3-5) connects inside handle 23 to latch release mechanism 33 to permit manual release of latch mechanism 32 from inside the passenger compartment of vehicle 10. Likewise, an outside latch release mechanism (see cable 82 in FIGS. 4-5) connects outside handle 21 to latch release mechanism 33 to permit manual release of latch mechanism 32 from outside of vehicle 10.

In addition, a power release actuator, also referred to as power actuator 102, associated with actuator module 24, is shown in FIGS. 7A-7D schematically connected to latch release mechanism 33. It is to be recognized any suitable power actuator arrangement is considered herein, such as disclosed in US Publication No. 2019/0136590, filed under U.S. application Ser. No. 16/182,790 on Nov. 7, 2018, owned by Applicant herein, which is incorporated herein by way of reference in its entirety. Actuation of power release actuator 102 causes latch release mechanism 33 to move pawl 38 from its ratchet holding position into its ratchet releasing position. As will be detailed, power release actuator 102 is an electric motor-driven arrangement. A ratchet switch lever (not shown) is mounted to ratchet 36 and works in cooperation with a ratchet release sensor (not shown) to provide a “door open” signal when ratchet 36 is located in its striker release position and a secondary latched sensor (not shown) to provide a “door ajar” signal when ratchet 36 is located in its secondary striker capture position. As is well known, these sensor signals are used by a latch control system integrated into actuator module 24 to control operation of power release actuator 102.

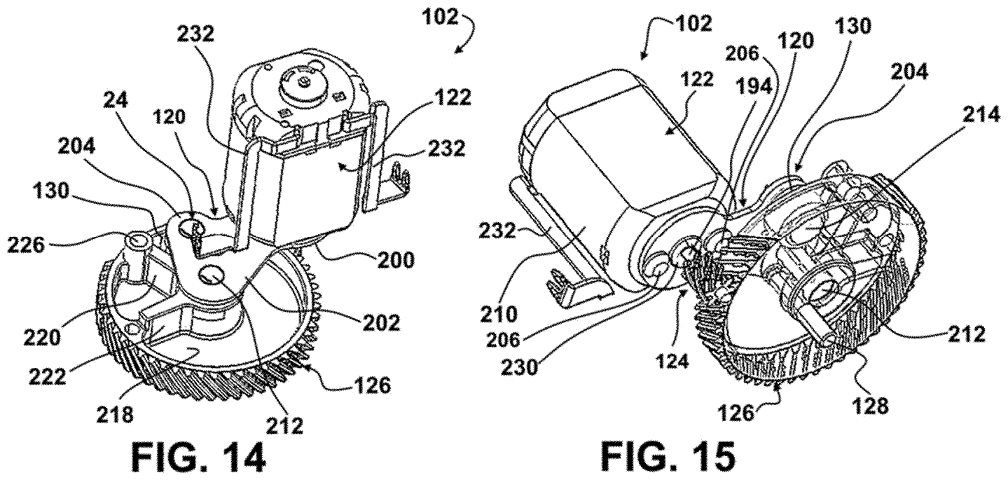

Referring again to FIG. 6, actuator module 24 is generally shown to include an ECU/actuator assembly 110 and an ECU cover 112, which together are secured to latch housing 30 of latch module 22 via attachment arrangement 26. ECU/actuator assembly 110 generally includes a housing plate 114, power actuator 102, and a control unit 116. As will be described in more detail, power actuator 102 is pre-assembled prior to mounting on housing plate 114 and generally includes a support member, also referred to as carrier plate 120, an electric motor 122 mounted to carrier plate 120 and having a motor shaft 194 driving a pinion gear 124, a power release gear, also referred to as drive gear 126, in constant meshed engagement with pinion gear 124 and having an actuation feature 128, such as an upstanding pin or cam member, by way of example and without limitation, configured to interact in operable communication with, either directly (engaging) or indirectly via an intermediate member (operably) with latch release mechanism 33, and a gear stop bumper 130 (FIGS. 14-16) mounted to carrier plate 120.

In this non-limiting configuration, power actuator 102 interacts with latch module 22 to provide a “power release” function by actuating latch release mechanism 33 to cause pawl 38 to move from its ratchet holding position into its ratchet releasing position. However, power actuator 102 could additionally, or alternatively, be configured to provide one or more other “powered” functions provided by latch module 22 such as, for example, power cinch or power lock/unlock. According to an aspect of the present disclosure, power actuator 102 is associated with actuator module 24 instead of latch module 22. Conventionally, power-operated closure latch assemblies have been configured with the power actuator installed in the latch module such that an ECU module only provided power and control signals to the power actuator. The present disclosure, in contrast, provides at least one power actuator 102 in combination with such an ECU module 116, thereby defining the term “actuator module” as used herein, which includes the ECU/Actuator assembly 110.

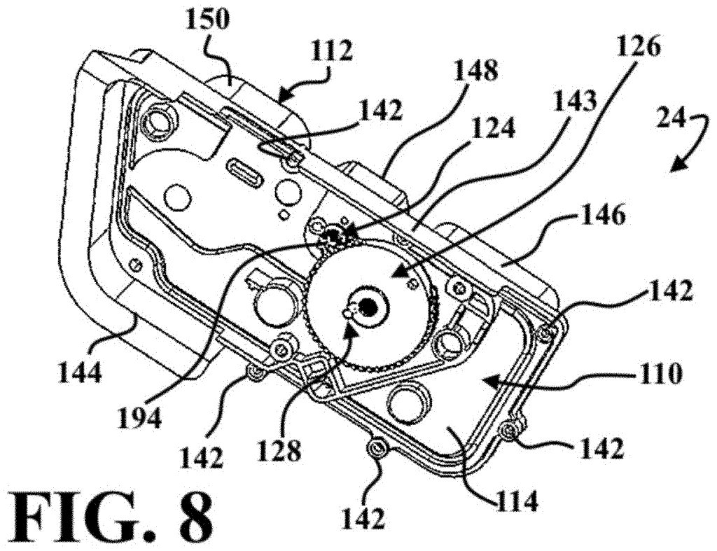

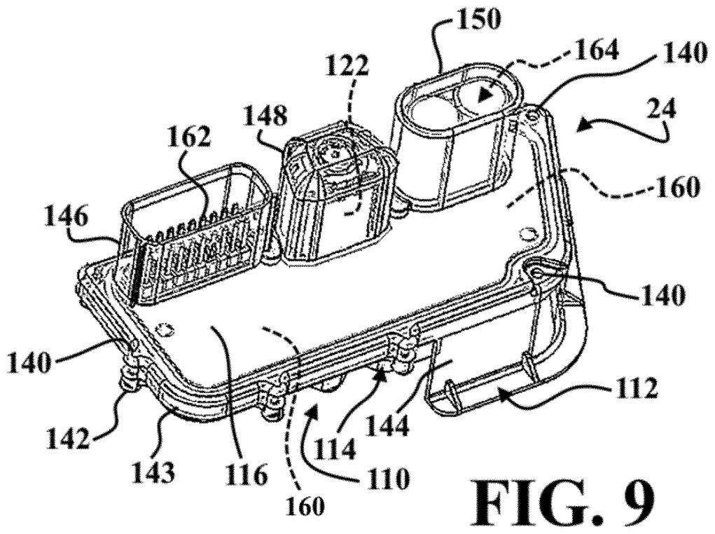

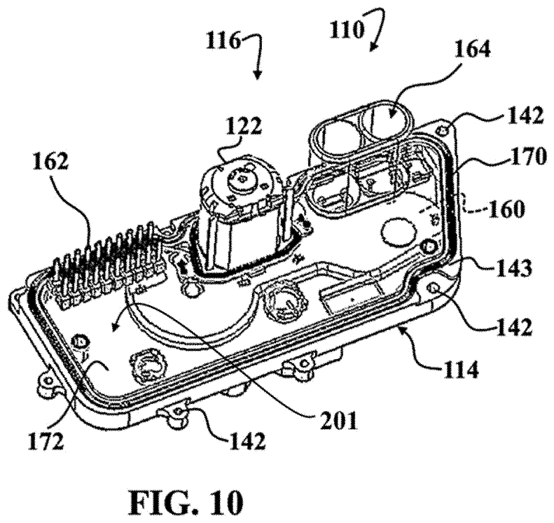

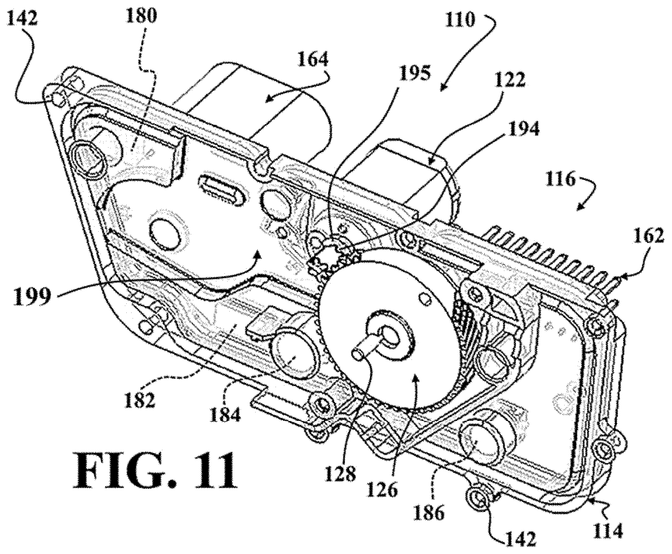

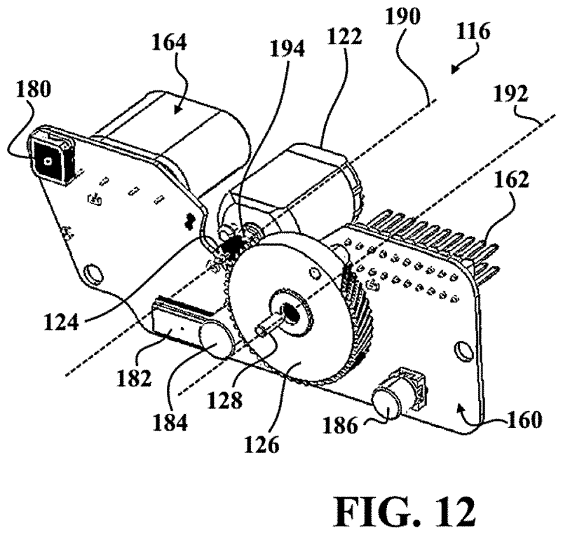

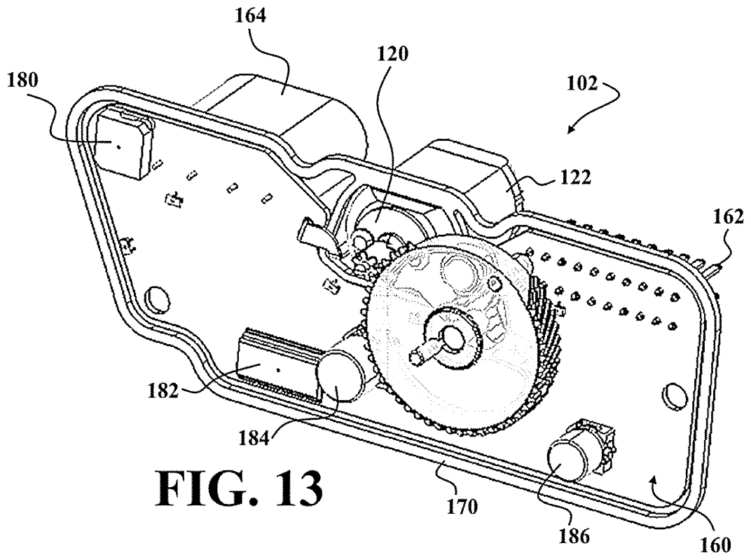

FIGS. 8 and 9 illustrate ECU cover 112 disposed about housing plate 114 and mounted on ECU/actuator assembly 110 with a plurality of mounting apertures 140 formed in ECU cover aligned with a similar plurality of alignment bores 142 formed in housing plate 114 of ECU/actuator assembly 110. A suitable fastening mechanism, such as mechanical fasteners, including rivets, screws, and bolts, by way of example and without limitation, define attachment arrangement 26 and are installed in aligned pairs of mounting apertures 140 in ECU cover 112 and alignment bores 142 in housing plate 114 to secure actuator module 24 to latch module 22. ECU cover 112 is shown best in FIG. 9 to include a plate segment 143, a peripheral shroud segment 144 extending outwardly from a plane of plate segment 143, and a plurality of upstanding enclosure segments 146, 148, 150 also extending outwardly from a plane of plate segment 143, shown as extending in an opposite direction from plate segment 143 as shroud segment 144. Enclosure segments 146, 148, 150 of ECU cover 112 are configured to receive and enclose distinct components associated with control unit 116. Specifically, plate segment 143 is arranged to accommodate and enclose a printed circuit board (PCB) 160 (FIGS. 12 and 13) which has been encapsulated/over-molded onto a first surface of housing plate 114. Likewise, enclosure segment 146 is a connector housing surrounding a plurality of connector contacts 162 extending from PCB 160 to define an electrical connector 162. In addition, enclosure segment 148 is a motor housing configured to enclose electric motor 122 which is mounted to carrier plate 120 and which, in turn, is encapsulated/over-molded on the first surface of housing plate 114. Finally, enclosure segment 150 is a capacitor housing configured to enclose one or more backup power devices, such as Super Capacitors 164 electrically connected to PCB 160. A peripheral seal 170 surrounds plate segment 143 of housing plate 114 and hermetically seals the first surface of housing plate 114 relative to ECU cover 112 to prevent the ingress of fluid and other forms of potential contamination therebetween. FIGS. 10 and 11 illustrate ECU/actuator assembly 110 with ECU cover 112 removed to better illustrate the components. Note that FIG. 10 best illustrates PCB 160 being encapsulated/over-molded onto plate segment 143 of housing plate 114, with reference number 172 identifying this layer of over-mold material (material overmolded onto PCB 160 to encapsulate and protect PCB).

FIGS. 12 and 13 illustrate control unit 116 assembled prior to being overmolded in fixed relation onto the first surface of housing plate 114. In addition to Super Capacitors 164 and connector contacts 162, other electrical components 180, 182, 184 and 186 are shown mounted to an underside surface of PCB 160. These additional components are located in corresponding retention cavities formed in housing plate 114, as shown in phantom in FIGS. 10 and 11. Line 190 (FIG. 12) indicates a motor axis for electric motor 122 and about which motor shaft 194 and pinion gear 124 rotates. Line 192 indicates a gear axis for drive gear 126 and about which actuation feature 128 rotates. Gear axis 192 is aligned to be generally parallel to motor axis 190. In addition, motor axis 190 is also aligned to be generally parallel to pawl axis 62′ of pawl pivot post 62 about which pawl 38 rotates. This is in stark contrast to conventional arrangements where the electric motor is housed in the latch module and has its motor axis transversely aligned relative to the pawl axis. This improved arrangement allows helical teeth to be used with pinion gear 124 and drive gear 126 instead of a worm gearset, although spur gear teeth can also be used. Note also that shaft 194 of motor 122 extends through an access port 195 extending through housing plate 114. This is the only access port through the sealed PCB 160/housing plate 114 interface which provides a simple and effective manner to seal the electronic components and motor housing. A closure latch assembly 18 is illustratively provided having a latch module, for example latch module 22, including a mechanism(s) operable in a first state and in a second state, and an actuator module, for example actuator module 24, 24A, 24B, 24C, 24D configured to be mounted to latch module 22. The actuator module includes a housing plate, such as housing plate 114, 114′ having a first side 199, 199′ facing the latch module 22 when the actuator module is mounted to the latch module 22, and an opposite second side 201, 201′ facing away from the latch module 22. The housing plate includes a port, such as port 195, 195′ 195″, extending from the first side 199, 199′ through to the opposite second side 201, 201′, for example as an aperture in the housing plate, for providing a passageway through the housing plate 114, 114′ interconnecting the first side 199, 199′ to the second side 201, 201′. The actuator module further includes a power actuator, such as power actuator 102, 102′, 102″, provided on the second side 201, 201′and including a shaft, such as the motor shaft 194, 194′, 194″, extending through the port 195, 195′ 195″, for allowing the shaft, such as the motor shaft 194, 194′, 194″, to, for example each, interact with the mechanism(s) of the latch module, such that the power actuator is/are for shifting the mechanism(s) from its first state into its second state, for example as a result of actuation of the shaft 194, 194′, 194″, for example a rotation or reciprocation, of the shaft 194, 194′, 194″. The actuator module further includes a control unit provided on the second side 201, 201′, such as control unit 116, for controlling actuation of the power actuator. The port 195, 195′ 195″ may be provided with a seal to prevent moisture, water, debris, dirt, grease, and/or other material(s), located on the first side 199, 199′ from penetrating into the actuator module, or onwards to the opposite second side 201, 201′ via the port 195, 195′ 195″, for the first side 199, 199′, to prevent interaction of such materials with the electronics and motor components of the sealed actuator module.

FIGS. 14 and 15 illustrate power actuator 102 pre-assembled as a stand-alone unit prior to mounting to housing plate 114 and prior to overmolded layer 172 enclosing PCB 160. While electric motor 122 is illustrated as being mounted to carrier plate 120 prior to overmolding, pre-assembled power actuator 102 may not include electric motor 122, which can be subsequently assembled with power actuator 102 subsequent to the overmolding step. Carrier plate 120 includes a motor mount segment 200, a gear support segment 202, and a bumper mount segment 204. Alternatively, bumper mount segment 204 may be provided as a pair of bumper mount segments 204 provided on stop lugs 220 and 222 to be engaged by naked rivet 214. A pair of screws 206 are used to rigidly mount a motor housing 210 of motor 122 to motor mount segment 200 of carrier plate 120. Drive gear 126 is rotatably mounted on a pivot shaft, also referred to as pivot rivet 212, extending from gear support segment 202 of carrier plate 120. In addition, gear stop bumper 130 is mounted via a rivet 214 to bumper mount segment 204 of carrier plate 120. Drive gear 126 is shown to define a cavity 218 within which gear stop bumper 130 is located. Stop lugs 220 and 222 formed within cavity 218 define the rotational limits for drive gear 126 due to engagement with gear stop bumper 130 in response to rotation of drive gear 126. The amount of rotation of drive gear 126 required for the power release function can be selected for each application. Furthermore, a magnet 226 associated with a Hall Effect sensor 228 (FIG. 6) is attached to stop lug 220. An O-ring seal 230 seals motor shaft 194 extending through housing plate 114. Motor leads 232 are electrically connected to circuit traces on PCB 160 and are subsequently over-molded via over-mold layer 172. The pre-assembly of electric motor 122 and drive gear 126 maintains proper mesh between pinion 124 and drive gear 126 and improves sensor activation (between magnet 226 and Hall Effect sensor 228) due to less variation in alignment during assembly.

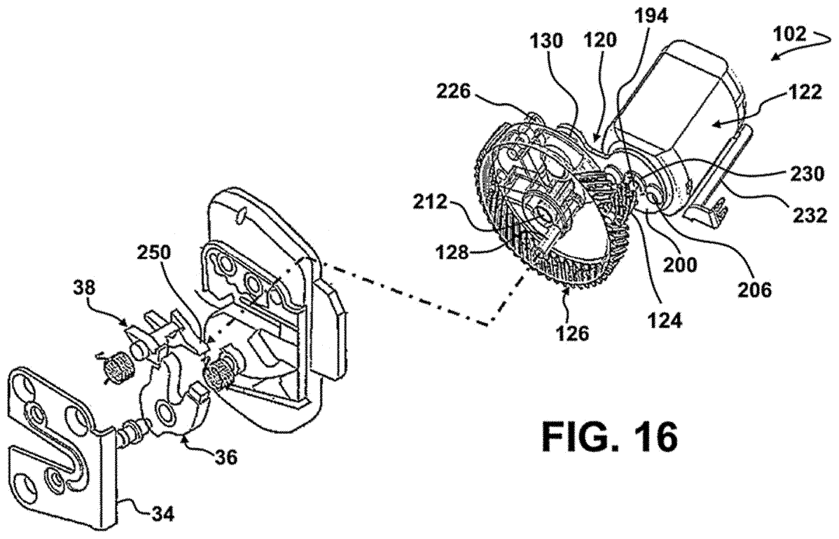

FIG. 16 illustrates actuation feature 128 configured in a non-limiting arrangement as a drive pin which is oriented in relation to a sector arm 250 (or pawl first leg segment 64 of FIGS. 7A-7D) formed on pawl 38 and which acts as latch release mechanism 33. Specifically, rotation of drive gear 126 from a home position to a released position via energization of electric motor 122 in response to a power release command causes drive pin 128 to engage sector arm 250 and drive pawl 38 from its ratchet holding position to its ratchet releasing position. Following power release, electric motor 122 is commanded to rotate drive gear 126 in the opposite direction back to its home position so as to reset latch release mechanism 33 to subsequently allow pawl 38 to move back into its ratchet holding position.

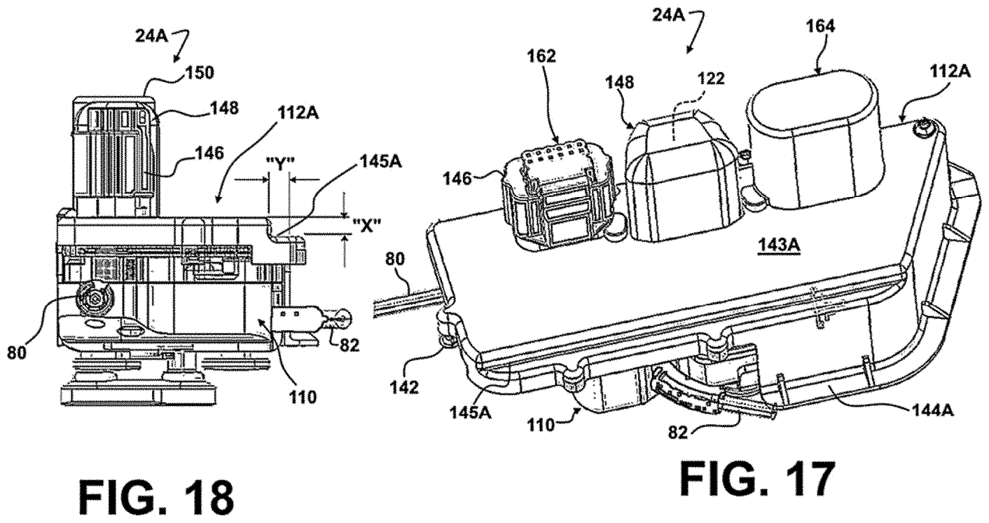

Referring now to FIGS. 17 and 18, a second non-limiting embodiment of an actuator module 24A for use with latch module 22 to define closure latch assembly 18 is shown to generally be configured as a slightly modified version of actuator module 24. In general, actuator module 24A includes ECU/actuator assembly 110 and a modified ECU cover 112A configured to provide a recessed portion 145A between plate segment 143A and peripheral shroud segment 144A. Recessed portion 145A defines an elongated notch with a height dimension “X” and a width dimension “Y”, the specific values of which can be selected to address various different applications. One application is when a maximized glass run channel is required within door 16. Housing plate (not shown) and seal (not shown) may require slight modifications as well, but the dimensions and orientation of the electronic components are not changed.

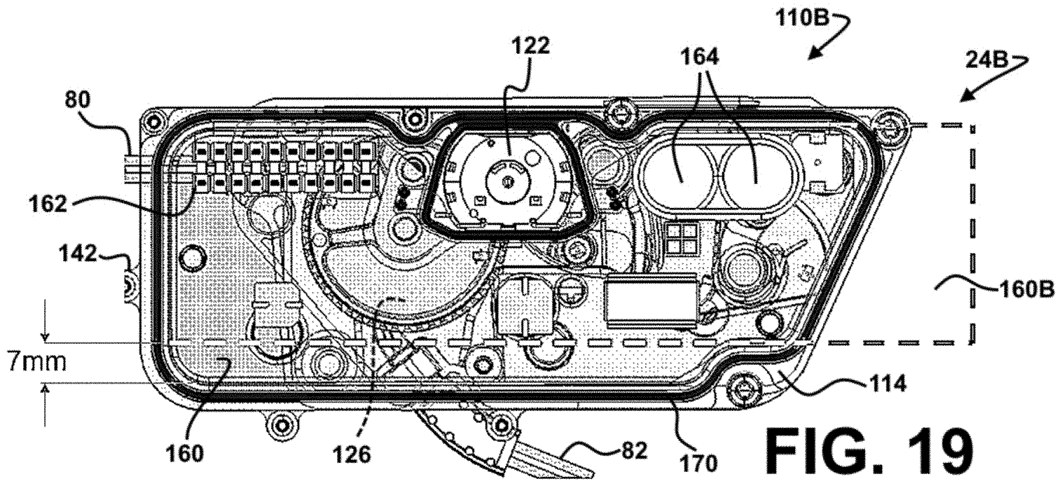

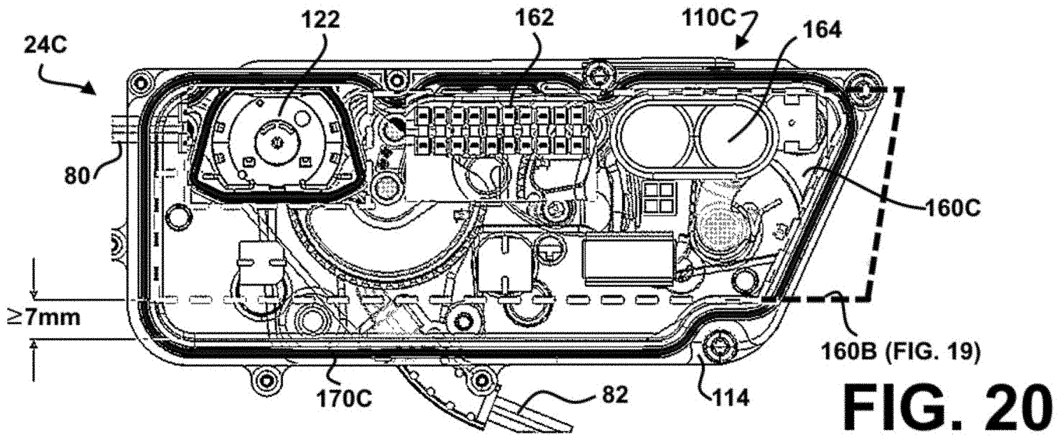

FIG. 19 illustrates a third non-limiting embodiment of an actuator module 24B for use with latch module 22 to define closure latch assembly 18. FIG. 19 illustrates actuator module 24B with an outline of a modified version of ECU/actuator assembly 110B (delineated by dashed lines) overlaid over ECU/actuator assembly 110 with ECU cover 112 removed. ECU/actuator assembly 110B reduces the width of PCB 160B while concomitantly increasing the length of PCB 160B. As part of this, the electronics would be relocated on PCB 160B. Thus, FIG. 19 merely illustrates an alternative configuration for an actuator module 24B providing all the functions previously disclosed in relation to actuator module 24.

FIG. 20 illustrates a revised version of actuation module 24C according to a fourth embodiment which is generally similar to actuator module 24B (FIG. 19) with the exception that the location of electric motor 122 and connector 162 have been switched on PCB 160C. This switched orientation permits PCB 160C to have reduced width and length dimensions in comparison to PCB 160B of FIG. 19.

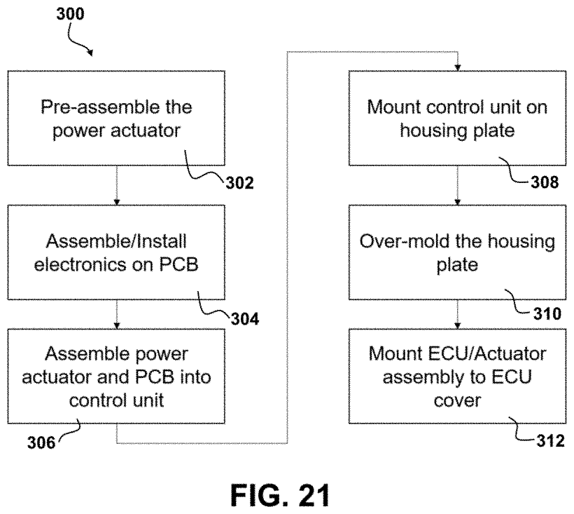

FIG. 21 is a block diagram of a simplified method for manufacturing and assembling actuator modules 24, 24A, 24B, 24C. In general, method 300 includes a series of steps and/or processes comprising: 302—pre-assembling power actuator 102; 304—assembling electronic components onto PCB 160; 306—assembling power actuator 102 and built-up PCB 160 to define control unit 116; 308—mounting control unit 116 on housing plate 114; 310—overmolding a layer of insulating material onto PCB 160 to enclose PCB 160 relative to housing plate 114 to define ECU/actuator assembly 110; and 312—mounting ECU cover 112 on ECU/actuator assembly 110 to define the actuator module.

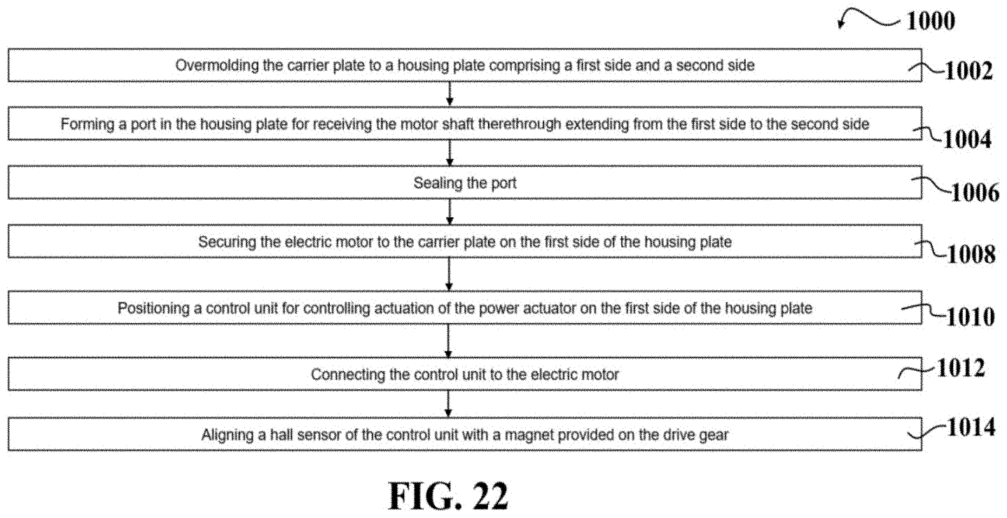

Now referring to FIG. 22, there is provided in accordance with an illustrative embodiment, a method 1000 of manufacturing an actuator module 24, 24A, 24B, 24C. The actuator module 24, 24A, 24B, 24C includes a power actuator 102 for shifting states of a latch module 22 including a latch mechanism 32 operable in a first state and in a second state. The power actuator 102 includes a carrier plate 120, an electric motor 122 securable to the carrier plate 120, the electric motor 122 including a motor shaft 194 driving a pinion gear 124. The power actuator 102 further includes a drive gear 126 rotatably mounted to the carrier plate 120 and meshed with the pinion gear 124. The method 1000 includes the step 1002 of overmolding the carrier plate 120 to a housing plate 114 comprising a first side and a second side, and the step 1004 of forming a port 195 in the housing plate 114 for receiving the motor shaft 194 therethrough extending from the first side to the second side. The method 1000 may further include the step 1006 of sealing the port 195 with a seal 230. The method 1000 may further include the step 1008 of securing the electric motor 122 to the carrier plate 120 on the first side of the housing plate 114, the step 1010 of positioning a control unit 116 for controlling actuation of the power actuator 102 on the first side of the housing plate 114, and the step 1012 of connecting the control unit 116 to the electric motor 122. The method 1000 may further include the step 1014 of aligning a hall sensor 228 of the control unit 116 with a magnet 226 provided on the drive gear 126.

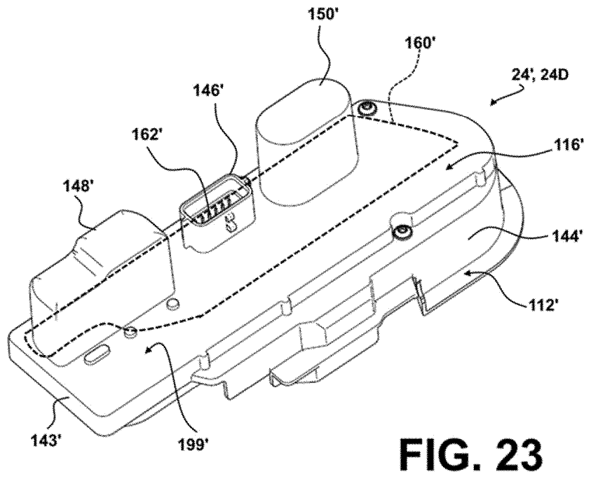

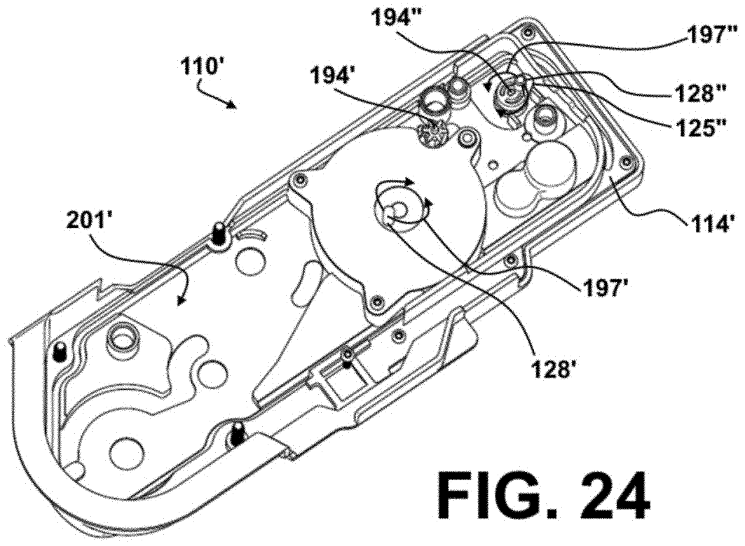

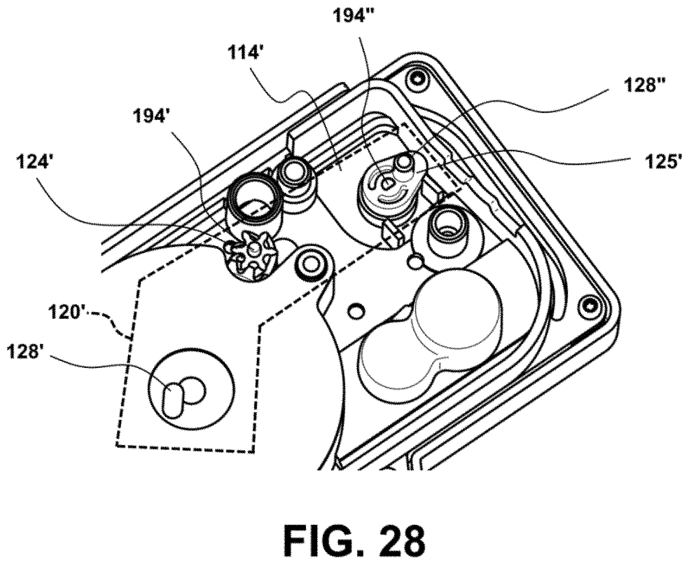

Now referring additionally to FIGS. 23 to 28, in accordance with another non-limiting configuration of the present disclosure, wherein the same reference numerals are used with an apostrophe symbol (') to designate like features, there is provided an actuator module 24D, also referred to using reference numeral 24′, including two power actuators 102′, 102″ which interact with a latch module to provide two “powered” functions by latch module 22 such as for example, respectively a power release and power lock/unlock. Power actuators 102′, 102″ are both associated with the actuator module 24′ instead of with latch module 22 such that two power actuators 102′, 102″ are provided in combination with the ECU module 116′, thereby defining the term “actuator module” as used herein, which includes the ECU/Actuator assembly 110′. More than two power actuators may be provided for in a similar manner.

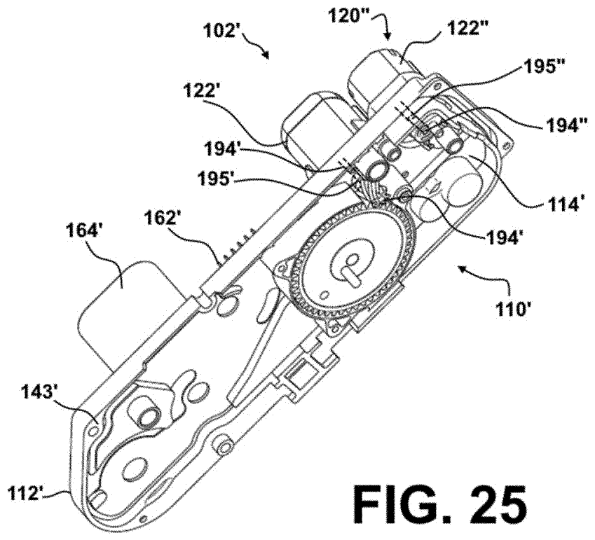

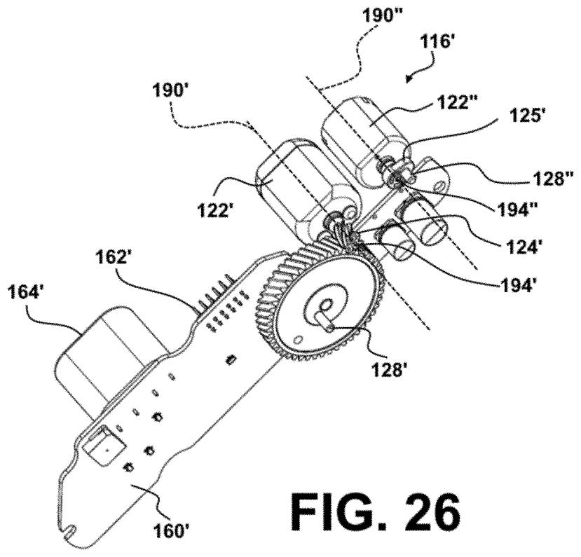

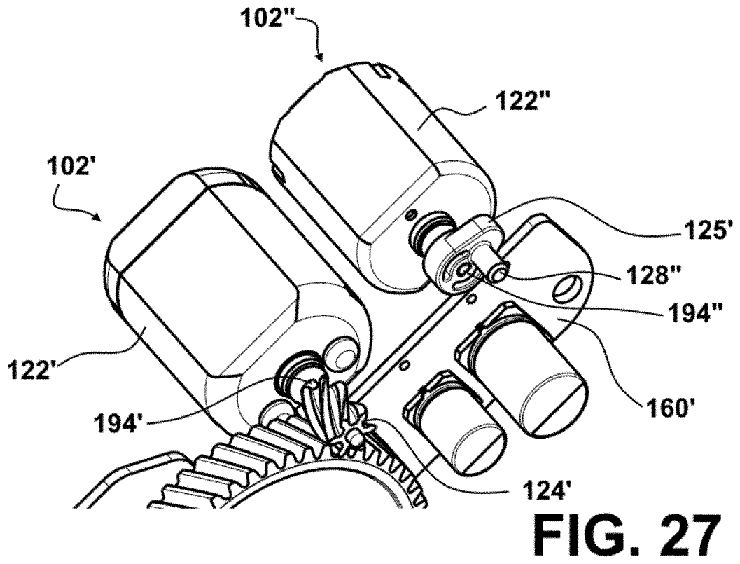

An ECU cover 112′ is shown best in FIG. 23 to include a plate segment 143′, a peripheral shroud segment 144′ extending outwardly from a plane of plate segment 143′, and a plurality of upstanding enclosure segments 146′, 148′, 150′ also extending outwardly from a plane of plate segment 143′, shown as extending in an opposite direction from plate segment 143′ as shroud segment 144′. Enclosure segments 146′, 148′, 150′ of ECU cover 112′ are configured to receive and enclose distinct components associated with control unit 116′. Specifically, plate segment 143′ is arranged to accommodate and enclose a printed circuit board (PCB) 160′ (FIGS. 26 and 27) which has been encapsulated/over-molded onto a first surface of housing plate 114′ in a manner as described herein above. Likewise, enclosure segment 146′ is a connector housing surrounding a plurality of connector contacts 162′ extending from PCB 160′ to define an electrical connector 162′. In addition, enclosure segment 148′ is a motor housing configured to now enclose two electric motors 122′, 122″ arranged side by side having motor shafts parallel to one another and perpendicular to a plane of PCB 160′ similar to the embodiments described hereinabove, which both may be mounted to a common carrier plate 120′ or to separate carrier plates, and which, in turn, is/are encapsulated/over-molded on the first surface of housing plate 114′. Finally, enclosure segment 150′ is a capacitor housing configured to enclose one or more backup power devices, such as Super Capacitors 164′ electrically connected to PCB 160′. FIGS. 25 to 27 illustrate ECU/actuator assembly 110′ with ECU cover 112′ removed to better illustrate the components.

Line 190′ (see FIG. 26) indicates a motor axis for electric motor 122′ and about which motor shaft 194′ and pinion gear 124′ rotate to cause associated rotation, via a gear train, of actuation feature 128′ as described herein above. Line 190″ (see FIG. 26) indicates a motor axis for electric motor 122″ and about which motor shaft 194″ and a radially extending support 125′ rotate to cause rotation of another actuation feature 128″. Second actuation feature 128″ is shown as directly coupled to motor shaft 194″ via a projecting support 125′ from motor shaft 194″ to share a common rotational center e.g. coaxial about line 190″. This arrangement allows a direct interaction of the actuation feature 128″ with a latch module 22 mechanism, such as an lock/unlock lever, for example, and without gearing inter-disposed between the motor 122″ and the actuation feature 128″, to actuate the latch mechanism between an unlock state, an example of a first state, and a locked state, and example of a second state. Of note is that shaft 194″ of motor 122″ extends through an associated access port 195″ extending through housing plate 114′. This access port 195″ is another access port through housing plate 114′ in addition to access port 195′ configured for receiving shaft 194′ of motor 122′ through the sealed PCB 160′/housing plate 114′ interface which provides a simple and effective manner to seal the electronic components and motor housing. Shafts 194, 194′, 194″ are illustratively shown herein as transmitting an actuation, for example rotation 197′, of an actuatable component e.g. shafts 194, 194′, 194″ extending between a first side 199′ from a second side 201′ of the housing plate 114′ in a sealed manner, but other types of movement of such an actuatable component may be provided, for example shafts 194, 194′, 194″ may be provided to reciprocate along their respective axis of the shafts 194, 194′, 194″ within the apertures 195, 195′, 195″ to provide a pushing or pulling action on a latch mechanism, as an example and without limitation.

With reference to FIGS. 1 to 28, the closure latch assembly 18 described herein may be installed in a closure panel of a motor vehicle, such as for example closure panel 16.

Thus, the present disclosure provides a stand-along integrated ECU and power actuator arrangement, referred to as the ECU/actuator assembly 110, for use in an actuator module 24, 24A, 24B, 24C, 24D configured to be mounted to an independent latch module 22. Accordingly, this actuator module 24, 24A, 24B, 24C, 24D can be used with different latch modules and/or different versions of the same latch module. The actuator module 24, 24A, 24B, 24C, 24D of the present disclosure now includes the power actuator 102, removed from the latch module 22, to integrate the electronics and electrically-actuated devices into a common assembly. Advantages of the present disclosure include: the ability to test, debug and calibrate the actuator module 24, 24A, 24B, 24C, 24D independently from the latch module 22; increase the precision of gear position detection by providing a pre-assembled power actuator 102 reducing stack-up tolerance between the meshed gears and the between the gear position sensor components; and fixing the motor 122, drive gear 126 and bumper 130 to a common structural component isolated from the latch housing 30 of the latch module 22 reducing noise and transmitted vibration.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A closure latch assembly, comprising:
a latch module including a mechanism operable in a first state and in a second state;
an actuator module including a power actuator for shifting the mechanism from its first state into its second state, and a control unit for controlling actuation of the power actuator; and
an attachment arrangement for securing the actuator module to the latch module.

2. The closure latch assembly of claim 1, wherein the actuator module includes an ECU/actuator assembly and an ECU cover.

3. The closure latch assembly of claim 2, wherein the ECU/actuator assembly includes a housing plate, and wherein the control unit is mounted to and at least partially over-molded on the housing plate.

4. The closure latch assembly of claim 3, wherein the control unit includes a printed circuit board (PCB) having at least one of an electrical connector and a backup power device, and wherein the control unit and the power actuator are part of a common assembly.

5. The closure latch assembly of claim 4, wherein the power actuator includes a carrier plate secured to the housing plate, an electric motor secured to the carrier plate and driving a pinion gear, a drive gear rotatably mounted to the carrier plate and meshed with the pinion gear, and a gear stop bumper secured to the carrier plate.

6. The closure latch assembly of claim 5, wherein the drive gear includes an actuation feature configured for operable communication with the mechanism within the latch module such that rotation of the drive gear from a first position to a second position via energization of the electric motor results in shifting of the mechanism from its first state into its second state.

7. The closure latch assembly of claim 1, wherein:
the actuator module includes a housing plate having a first side facing the latch module and an opposite second side, and having a port extending from the first side to the opposite second side; and
the power actuator includes an electric motor provided on the opposite second side, the electric motor having a motor shaft extending through the port.

8. The closure latch assembly of claim 7, wherein the drive gear is a power release gear such that rotation of the drive gear from its first position to its second position shifts a latch release mechanism for shifting the latch mechanism from its latched state into its released state.

9. The closure latch assembly of claim 6, wherein the mechanism in the latch module is a latch mechanism having a ratchet and pawl, wherein the pawl is operable in a ratchet holding position to hold the ratchet in a striker capture position and is operable in a ratchet releasing position to permit the ratchet to move to a striker release position, and wherein the rotary axis of the pinion gear driven by the electric motor is parallel to the axis of the pawl.

10. The closure latch assembly of claim 3, wherein the power actuator includes a carrier plate overmolded to the housing plate, an electric motor secured to the carrier plate comprising a motor shaft extending through a port in the housing plate and driving a drive pinion, a drive gear rotatably mounted to the carrier plate and meshed with the drive pinion, and a gear stop bumper secured to the carrier plate.

11. The closure latch assembly of claim 5, wherein an axis of the drive pinion is parallel to an axis of the drive gear.

12. The closure latch assembly of claim 11, wherein the drive gear is a helical gear.

13. A method of manufacturing an actuator module including a power actuator for shifting states of a separate latch module from a latched state to an unlatched state, the latch module including a latch mechanism operable in a first state to maintain the latch module in the latched state and in a second state to release the latch module to the unlatched state, the power actuator including a carrier plate, an electric motor securable to a first side of the carrier plate and comprising a motor shaft driving a pinion gear on a second side of the carrier plate, and a drive gear rotatably mounted on the second side of the carrier plate and meshed with the pinion gear, the method comprising the steps of:
overmolding the carrier plate to a first side of a housing plate; and
forming a port extending from the first side through an opposite second side of the housing plate and extending the motor shaft therethrough.

14. The method of manufacturing an actuator module of claim 13, further comprising the step of securing the electric motor to the carrier plate on the first side of the housing plate, positioning a control unit for controlling actuation of the power actuator on the first side of the housing plate, and connecting the control unit to the electric motor to establish electrical communication between the control unit and the electrical motor.

15. The method of manufacturing an actuator module of claim 14, further comprising the step of aligning a hall sensor of the control unit with a magnet provided on the drive gear.

16. The method of manufacturing an actuator module of claim 14, further including disposing an ECU cover about the housing plate and configuring the ECU cover to secure the actuator module to the latch module via an attachment arrangement.

17. The method of manufacturing an actuator module of claim 16, further including providing the attachment arrangement including at least one mechanical fastener.

18. The method of manufacturing an actuator module of claim 14, wherein the latch mechanism has a ratchet and pawl, wherein the pawl is operable in a ratchet holding position to hold the ratchet in a striker capture position and is operable in a ratchet releasing position to permit the ratchet to move to a striker release position, and configuring the drive gear as a power release gear such that rotation of the drive gear from a first position to a second position shifts the ratchet from the striker capture position to the ratchet releasing position.

19. The method of manufacturing an actuator module of claim 18, further including arranging the rotary axis of the pinion gear driven by the electric motor in parallel relation to a rotary axis of the pawl.

20. A closure latch assembly, comprising:
a latch module including a mechanism operable in a first state and in a second state; and
an actuator module comprising:
a housing plate comprising a first side facing the latch module and an opposite second side, and a port extending from the first side through to the opposite second side;
a power actuator provided on the opposite second side and comprising a motor shaft extending through the port, the power actuator for shifting the mechanism from its first state into its second state; and
a control unit provided on the opposite second side for controlling actuation of the power actuator.
